(19) United States
(12) Patent Application Publication
(10) Pub. No.: US 2006/0044453 A1
(43) Pub. Date: Mar. 2, 2006

(54) Method of controlling digital photographing apparatus, and digital photographing apparatus adopting the method

(75) Inventor: Dong-whan Lee, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/026,964

(22) Filed: Dec. 30, 2004

(30) Foreign Application Priority Data
Aug. 27, 2004 (KR) 2004-68005

(51) Int. Cl. H04N 5/232; G03B 13/00

(52) U.S. Cl. 348/345

(57) ABSTRACT

A method of controlling a digital photographing apparatus is provided. The apparatus outputs an attention-grabbing sound and photographs a subject according to the subject's distance from the apparatus after outputting the attention-grabbing sound. A digital photographing apparatus adopting the method is also provided.

### CROSS-REFERENCE TO RELATED PATENT APPLICATIONS

This application claims the priority of Korean Patent Application No. 2004-68005, filed on Aug. 27, 2004, in the Korean Intellectual Property Office, the disclosure of which is incorporated herein in its entirety by reference.

### BACKGROUND OF THE INVENTION

1. Field of the Invention

The present invention relates to a digital photographing apparatus, and more particularly to a method for controlling a digital photographing apparatus.

2. Description of the Related Art

Many digital photographing apparatuses such as digital cameras, camcorders and the like are capable to receive, store and playback audio data. For example a user may take a still picture or record a moving picture (e.g., movie) with an associated sound such as a voice note or dialogue between the subject and the user of the apparatus. To this end, audio recording/playback devices are well known in the art and include tape recorders utilizing a magnetic tape recording medium, digital devices including integrated circuit (IC) chips such as digital signal processors (DSP) and the like. As is known, digital audio recording devices typically compress the audio data via an audio codec and store the compressed audio data in a memory. Later, the audio data stored in the memory is uncompressed and reproduced. However, when recording audio data (e.g., a voice message) with a digital audio recording device, noise (e.g., ambient sounds) may be inadvertently recorded along with the audio data. Further, recording sensitivity of the digital audio recording device may be low, and since storage space (i.e., memory) may be limited, there may be a limit to the quantity and/or quality of audio data that can be stored.

It is well known in photography for the photographer to enunciate a sound or word such as “cheese” or “smile” in order to prepare the subject for having his or her picture taken, which often results in a better photograph of the subject since the subject's attention is directed to the photographer and camera. However, it may be difficult for the photographer to synchronize or otherwise coordinate the focusing of the photographing apparatus, enunciating of the sound and controlling of the shutter. In view of the foregoing, it would be desirable to provide a photographing method and apparatus that facilitates the taking of better photographic images by outputting an attention-grabbing sound.

### SUMMARY OF THE INVENTION

A method of controlling a digital photographing apparatus is provided. The apparatus outputs an attention-grabbing sound and photographs a subject according to the subject's distance from the apparatus after outputting the attention-grabbing sound.

According to an aspect of the present invention, a method is provided for controlling a digital photographing apparatus that photographs a subject using a two-step shutter release button. The apparatus stores an image file in a recording medium, plays the image file stored in the recording medium and displays the image on a display panel. The method includes the steps of: performing automatic focusing according to a distance of the subject from the digital photographing apparatus when a first-step signal of the shutter release button is turned “on”; determining if the distance of the subject from the digital photographing apparatus is within a predetermined range relative to the automatic focusing; outputting a sound corresponding to audio data pre-stored in a memory; and storing an image file of the subject in the recording medium when a second-step signal of the shutter release button is turned “on”.

One exemplary predetermined range for the foregoing method and apparatus is between approximately 0.3 m and 3 m. When the digital photographing apparatus is set to a portrait photographing mode, the sound corresponding to audio data pre-stored in a memory is output if the distance between the subject and the apparatus is determined to be within the predetermined range. Further, the sound may be selected by the user from a plurality of languages relative to selecting the on-screen display language of the digital photographing apparatus.

According to another aspect of the present invention, a digital photographing apparatus adopting the foregoing method is provided.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a digital camera illustrating the top and front thereof according to an embodiment of the present invention;

FIG. 2 is a rear view of the digital camera of FIG. 1;

FIG. 3 is a block diagram of the digital camera of FIG. 1;

FIG. 4 is a block diagram illustrating the optical system of the digital camera of FIG. 1;

FIG. 5 is a flowchart illustrating a main algorithm of a digital camera processor illustrated in FIG. 3;

FIG. 6 is a flowchart illustrating an algorithm for performing a preview mode shown in FIG. 5; and

FIG. 7 is a flowchart illustrating an algorithm of a photographing mode shown in FIG. 5.

### DETAILED DESCRIPTION OF THE INVENTION

The present invention will now be described more fully with reference to the accompanying drawings, in which exemplary embodiments of the invention are shown.

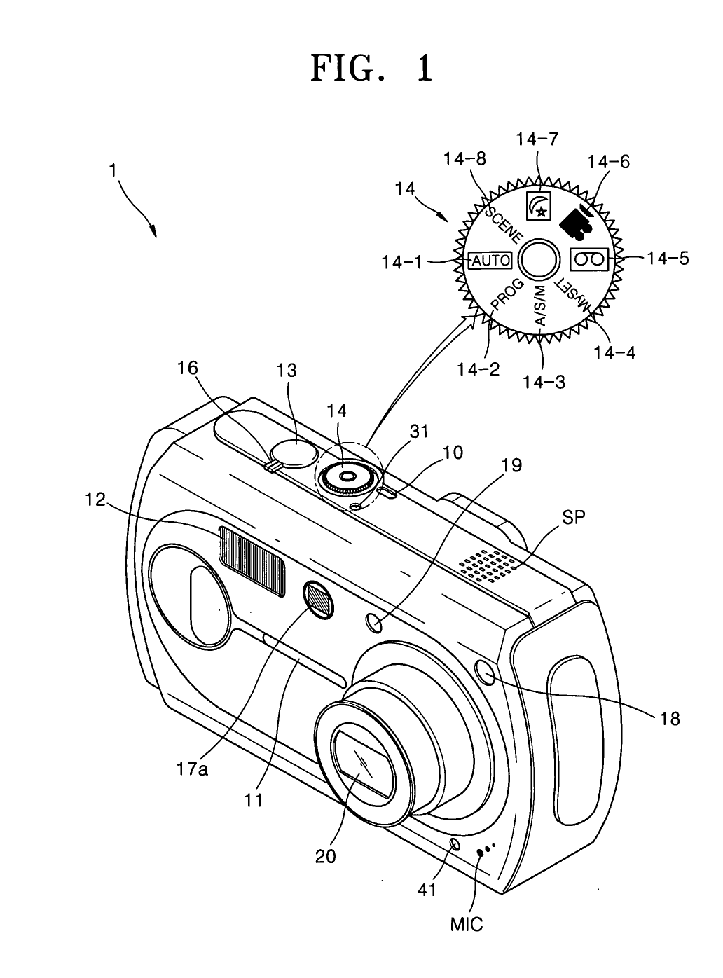

Referring to FIG. 1, a digital camera 1, which is a digital photographing apparatus, according to an exemplary embodiment of the present invention includes a microphone MIC, an operate/self-timer lamp 11, a flash 12, a view finder 17a, an automatic focus aiding light 18, a flash light amount sensor (FS) 19, a lens unit 20, and a remote control sensor 41 on its front, and a speaker SP, a mode dial lamp 10, a shutter release button 13, a mode dial 14, a jog dial 16, and a power button 31 on its top.

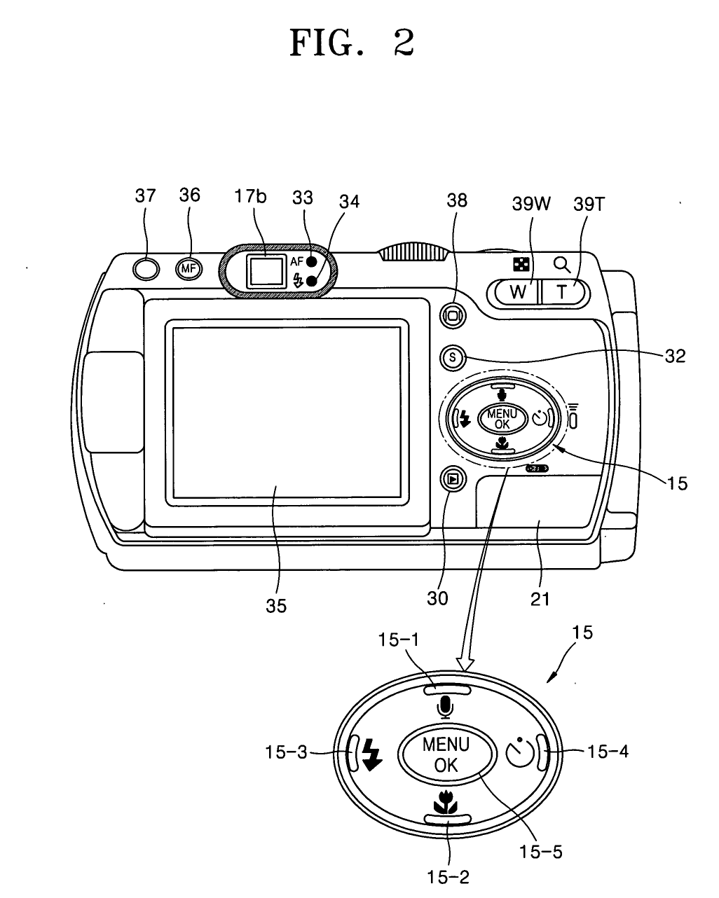

The mode dial lamp 10 is lit when a screen of a color liquid display panel (LCD) 35 (see FIG. 2) is turned “off” by pressing an LCD button 38 (see FIG. 2).

The operate/self-timer lamp 11 operates to indicate a power-on state, a moving picture photographing state, an audio recording state, a photographing state, or a remote controlling state. Also, when operating a self-timer, the operate/self-timer lamp 11 operates for a predetermined amount of time from an instance that the shutter release button 13 is pressed until an instance that an image is captured.

The shutter release button 13 has a two-step structure and operation. If the shutter release button 13 is pressed only up to a first step (e.g., a first detent or stop), a SH1 signal from the shutter release button 13 is turned “on”. If the shutter release button 13 is further pressed to a second step (e.g., a second detent or stop below the first step), a SH2 signal from the shutter release button 13 is turned “on”.

The mode dial 14 is used to select and set an operating mode among a plurality of operating modes of the digital camera 1. The plurality of operating modes may include, for example, an automatic photographing mode 14-1, a program photographing mode 14-2, an A/S/M photographing mode 14-3, a MySET photographing mode 14-4, an audio recording mode 14-5, a moving picture photographing mode 14-6, a night scene photographing mode 14-7, and a scene photographing mode 14-8.

As one can appreciate, the automatic photographing mode 14-1 enables quick and easy photographing by minimizing user manipulation of the digital camera's functions and/or settings.

The program photographing mode 14-2 enables the user to set various functions of the digital camera 1, excluding an aperture value and shutter speed.

The A/S/M photographing mode 14-3 enables the user to set various functions of the digital camera 1 including the aperture value and shutter speed. “A” denotes aperture priority photographing mode, “S” denotes a shutter speed priority photographing mode, and “M” denotes a manual photographing mode.

The MySET photographing mode 14-4 enables frequently used camera shooting settings to be stored in the digital camera 1 and recalled later.

The audio recording mode 14-5 enables only audio data to be recorded for a predetermined duration determined by the storage space of a memory and stored in the memory. The file format of the audio data may be “wav”. Other audio data file formats such as “MP3” and the like known in the art may be used as well.

The moving picture photographing mode 14-6 enables moving picture (i.e., movie) data including video and audio data to be recorded for a predetermined duration determined by the storage space of the memory and stored in the memory. The file format of the moving picture data may be “mov”. Other moving picture data file formats known in the art may be used as well.

The night scene photographing mode 14-7 enables photographing at night or in dark surroundings.

The scene photographing mode 14-8 enables the user to simply set the optimum setting of the digital camera 1 according to the state of a subject or photographing conditions (e.g., portrait, landscape, close-up, sunset, dawn, sun behind subject, fireworks, beach, or snowscape) via a menu.

The jog dial 16 controls a focal length when controlling a focus manually and controls an aperture value and a shutter speed in the A/S/M photographing mode 14-3.

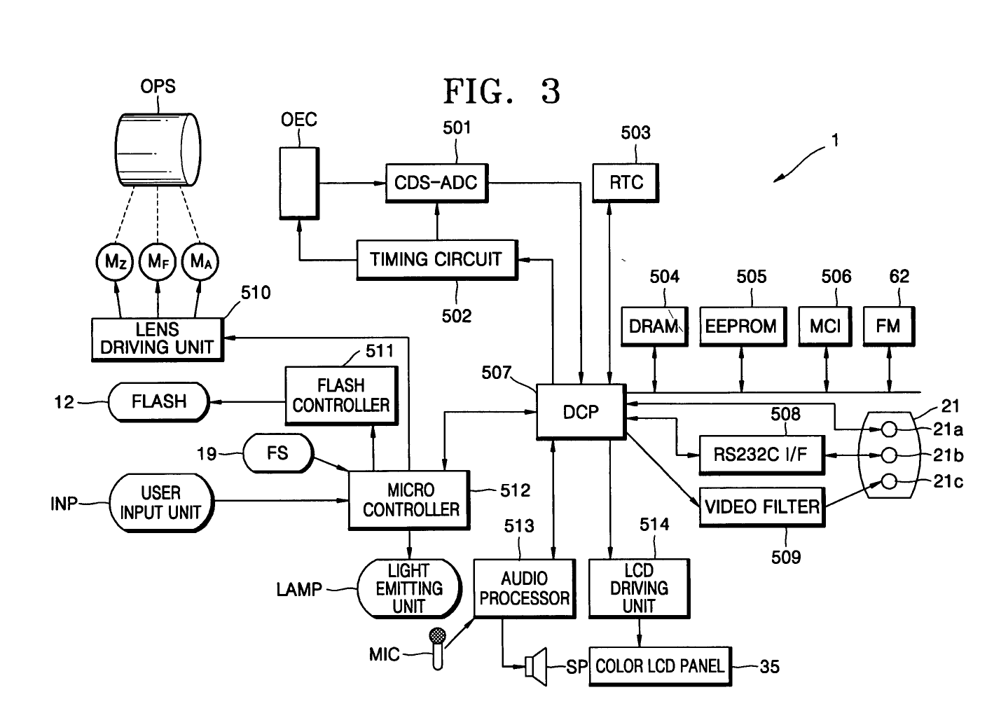

The FS 19 senses the light amount of the flash 12 when the flash 12 is operating and inputs the sensed light amount to a digital camera processor (DCP) 507 (see FIG. 3) via a micro-controller 512 (see FIG. 3). As known in the art, the DCP 507 may be embodied by a digital signal processor (DSP) or the like.

The remote control sensor 41 receives a photographing command signal from a remote control (not shown), and inputs it to the DCP 507 via the micro-controller 512. As known in the art, the remote control may send wireless signals to the digital camera 1 via radio frequency (RF), infrared (IR) or the like.

Referring to FIG. 2, function buttons 15, an external interface unit 21, a play mode button 30, an “S” button 32, an automatic focus indicator lamp 33, a flash indicator lamp 34, the color LCD panel 35, a manual focus/delete button 36, an automatic exposure lock/copy button 37, the LCD button 38, a zoom “W” button 39W, and a zoom “T” button 39T, are included on the back of the digital camera 1. The function buttons 15 are used to perform particular functions of the digital camera 1, and also act as direction-movement keys of an activated cursor (e.g., a joypad) on a menu screen of the color LCD panel 35. As best illustrated in the detail view of FIG. 2, the function buttons 15 include an audio memo/up button 15-1, a macro/down button 15-2, a flash/left button 15-3, a self-timer/remote control/right button 15-4, and a menu/OK button 15-5.

If the audio memo/up button 15-1 is pressed while the menu screen is displayed on the color LCD panel 35, a cursor on a lower menu moves upwards, and when the menu screen of the panel 35 is not displayed, an audio memo can be recorded and associated with a stored photograph.

If the macro/down button 15-2 is pressed while the menu screen is displayed, a cursor on a main menu may move to a lower menu or a cursor on the lower menu may move down. Also, an object at close-range can be photographed if the macro/down button 15-2 is pressed when the menu screen is not displayed.

If the flash/left button 15-3 is pressed while the menu screen is displayed, a menu tab on the left may be selected, and when the menu screen is not displayed, the flash/left button 15-3 is used as a flash button.

The flash modes include an automatic flash mode, a fill-in mode, a red-eye reduction mode, a slow shutter mode, and a flash off mode. In the automatic flash mode, the flash 12 automatically flashes when a subject or a landscape is dark and does not flash if the subject and surroundings are sufficiently illuminated. In the fill-in mode, the flash 12 always flashes regardless of the brightness of the subject or the surroundings but flashes with a light amount that is automatically controlled according to the brightness of the surroundings so that the image does not disadvantageously become over-illuminated. In the red-eye reduction mode, in order to prevent red-eye caused by sudden expansion of the subject's pupils in dark places, a preliminary flash operates before a shutter (not shown) opens, to adjust the subject's pupils, and then a photograph is taken together with another flash of the flash 12. In the slow shutter mode, the shutter is operated slowly together with the flash 12 in order to obtain a brighter image of the subject and the background when the background is dark, for example, at twilight. In the flash off mode, the flash 12 does not operate. The flash off mode may be used in places where flash photography is not allowed, such as art galleries and museums, or when desiring to take a refined photograph of an interior.

If the self-timer/remote control/right button 15-4 is pressed while the menu screen is displayed on the color LCD panel 35, a menu tab on the right is selected. If the self-timer/remote control/right button 15-4 is pressed while the menu screen is not displayed on the color LCD panel 35, photographing is performed after a preset time has passed. This function may be used for photographing oneself by allowing the user sufficient time to position his or herself in front of the digital camera 1.

If the menu/OK button 15-5 is pressed while the menu screen is displayed, data values can be changed and stored using the function buttons 15. When the menu screen is not displayed on the panel 35, a menu screen for each camera operation may be displayed by pressing the menu/OK button 15-5. If the menu/OK button 15-5 is pressed again, an original screen reappears on the panel 35.

The external interface unit 21 is composed of, for example, a means for connecting the digital camera 1 with another electronic component (e.g., a personal computer, printer, television, etc.) In one exemplary embodiment, the interface unit 21 may include a universal serial bus (USB) port and an audio-visual (AV) input terminal, but other ports and jacks may be included in addition to or instead of the foregoing examples.

An image or a moving picture stored in the memory can be played by pressing the play mode button 30 in a play mode. Alternatively, the play mode can be changed to a photographing mode by pressing the play mode button 30.

As known in the art and previously mentioned, exposure compensation, white balance, sensitivity (ISO), RGB, the A/S/M photographing mode, and a long-time shutter mode may be selected. The exposure compensation enables automatic control of exposure to an appropriate level by using the “S” button 32. The white balance enables attainment of an image with natural colors. The ISO enables selection of sensitivity when photographing an image, and is displayed after conversion into a number. As the ISO rating increases, the sensitivity of a camera increases as well as the photographing ability of the camera in dark places, but disadvantageously the noise in an image increases, making the image grainy. The RGB enables the user to control red (R), green (G), and blue (B) values of an image to be photographed. The A/S/M is a menu for setting an aperture value or shutter speed. In the “A” (aperture-first) photographing mode, a shutter speed is automatically set after an aperture value is decided to maintain an appropriate level of exposure according to the brightness of the subject. The aperture value may be altered by turning the jog dial 16 left/right. In the “S” (shutter-first) photographing mode, an aperture value is automatically set after a shutter speed is set to maintain an appropriate level of exposure according to the brightness of the subject. The shutter speed may be changed by turning the jog dial 16 left/right. In the “M” (manual) photographing mode, a shutter speed and an aperture value are both set manually by the user. In the long-time shutter mode, the user may set a shutter speed and an aperture value in the night-scene photographing mode.

When the shutter release button 13 is pressed to the first-step (e.g., depressed by the user's finger to a first detent or stop), the automatic focus indicator lamp 33 lights up if an image is well-focused. Alternatively, the automatic focus indicator lamp 33 remains unlit if the image is not well-focused.

The flash indicator lamp 34 is unlit if the flash 12 is charging and the flash indicator lamp 34 lights up when the flash 12 is charged and it the digital camera 1 is ready to photograph using the flash 12.

The manual focus/delete button 36 is used to select a focusing method. Each time the manual focus/delete button 36 is pressed, the focusing mode changes. For example, by pressing the manual focus/delete button 36, the digital camera 1 may cycle through the focusing modes in the order of: manual focus, continuous automatic focus, and automatic focus. In the automatic focus mode, the distance from a subject to the digital camera 1 is measured when the shutter release button 13 is pressed to the first-step, thereby enabling the most appropriate focal length to be calculated. If the subject is brought into focus when the shutter release button 13 is pressed up to the first-step, an automatic focus mark (e.g., indicator lamp 33) turns green. In the manual focus mode, the focus of the digital camera 1 is manually altered by the user. This manual focus mode may be used when the user wants additional control over the focus settings, for example, in dark places so that the image is not blurred. In the continuous automatic focus mode, the digital camera 1 automatically controls the focal length at all times and adjusts the focus if the relative positions of the camera and subject change, even when the shutter release button 13 is not depressed up to the first-step. In the continuous automatic focus mode the digital camera 1 may be continuously ready to capture an image, and therefore the automatic focus mode may cause the digital camera 1 to consume more power than in the automatic focus mode. Also, the manual focus/delete button 36 may be used for deleting images stored in a memory card (e.g., when viewing the stored images).

In a photographing environment in which illumination is strong or the source of illumination is located behind the subject (i.e., backlighting), if the automatic exposure lock/copy button 37 is pressed and the difference in an exposure value between subject and background is high, an appropriate exposure value may be manually set. Also, the automatic exposure lock/copy button 37 may be used for copying an image stored in the memory card to another memory card.

The currently set photographing information may be checked by pressing the LCD button 38, which displays the information on the color LCD panel 35. An image may be manipulated (e.g., rotated by 180°) by the user and displayed on the color LCD panel 35 by pressing the LCD button 38. Also, by pressing the LCD button 38, the background of a menu displayed on the panel 35 may be made darker to improve visibility of the menu. Further, an image displayed on the panel 35 may be displayed without any photographing information by pressing the LCD button 38.

By pressing the zoom “W” button 39W and the zoom “T” button 39T an optical zoom and a digital zoom enable an image to be displayed on the panel 35 on an enlarged or reduced scale. Further, in an image display mode, the buttons 39W, 39T permit a plurality of photographs may be viewed together (e.g., thumbnail format), or permit only a desired portion of a photograph to be displayed. Moreover, the foregoing desired portion of a photograph may be cut and stored (i.e., image cropping).

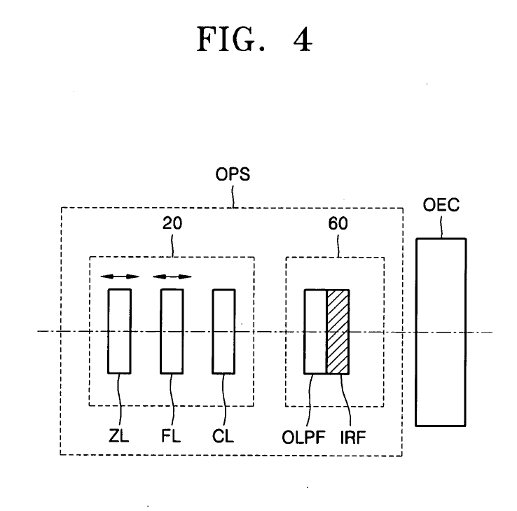

FIG. 3 is a block diagram showing the overall structure of the digital camera 1 of FIG. 1, and FIG. 4 is a diagram illustrating the optical system of the digital camera 1 of FIG. 1 on which light is incident. Referring to FIGS. 1 through 4, the overall structure and operation of the digital camera 1 will now be described.

As shown in FIG. 4, an optical system OPS, which includes the lens unit 20 and a filter 60, optically processes light reflected from a subject. The lens unit 20 of the optical system OPS includes a zoom lens ZL, a focus lens FL, and a compensation lens CL.

If a user presses the zoom “W” button 39W or the zoom “T” button 39T included in a user input unit INP (FIG. 3), a signal corresponding to the zoom “W” button 39W or the zoom “T” button 39T is input to the micro-controller 512. Accordingly, the micro-controller 512 controls a lens driving unit 510 and operates a zoom motor M_{Z}, thereby operating the zoom lens ZL. More specifically, if the zoom “W” button 39W is pressed, a focal length of the zoom lens ZL is shortened, thereby increasing a view angle of the lens unit 20. Alternatively, if the zoom “T” button 39T pressed, a focal length of the zoom lens ZL is lengthened, thereby decreasing a view angle of the lens unit 20. One can appreciate that since the location of the focus lens FL is controlled while the location of the zoom lens ZL is fixed, the view angle is hardly affected by the location of the focus lens FL.

In automatic focus mode, a main controller (not shown) embedded in the DCP 507 controls the lens driving unit 510 via the micro-controller 512, thus operating a focus motor M_{F} so that the focus lens FL moves. In the focusing process, the locations of the focus lens FL are set at locations at which high frequency components of an image signal are highest according to the number of operating steps of the focus motor M_{F}. One exemplary focus motor M_{F} may be a stepping motor or the like for detecting the number of operating steps. As one can appreciate, the distance of the subject from the digital camera 1 can be calculated or otherwise determined by using experimental values relative to the relationship between the numbers of operating steps of the focus motor M_{F} required to focus the lens unit 20 on the subject The compensation lens CL of the optical system OPS acts to compensate the overall refractive index, and thus is not operated independently from lenses ZL and FL. M_{A} (FIG. 3) denotes a motor for driving an aperture (not shown), such as the camera's shutter.

In the filter unit 60 of the optical system OPS, an optical low-pass filter (OLPF) removes high-frequency optical noise. An infrared cut filter (IRF) blocks incident infrared light.

A photoelectric converter (OEC) of a charge coupled device (CCD) or complementary metal oxide semiconductor (CMOS) (not shown) converts light from the optical system OPS into analog electrical signals. The DCP 507 controls a timing circuit 502 and the operation of an analog-to-digital converter (ADC) 501. The ADC 501 may be a correlation double sampler (CDS) and analog-to-digital converter (ADC), hereinafter CDS-ADC, which processes the analog signals from the photoelectric converter OEC and converts the analog signals into digital signals after removing high-frequency noise and altering the signals bandwidth. The DCP 507 processes the digital signals from the CDS-ADC 501 and generates digital image signals that include brightness and chromaticity signals.

A real-time clock (RTC) 503 provides timing information to the DCP 507.

A light emitting unit LAMP that is operated by the micro-controller 512 according to control signals from the DCP 507 includes the operate/self-timer lamp 11, the automatic focus indicator lamp 33, and the flash indicator lamp 34. The user input unit INP includes, but is not limited to the aforementioned buttons such as: the shutter release button 13, the mode dial 14, the function buttons 15, the jog dial 16, the play mode button 30, the power button 31, the “S” button 32, the manual focus/delete button 36, the automatic exposure lock/copy button 37, the zoom “W” button 39W, and the zoom “T” button 39T.

The digital image signal transmitted from the DCP 507 is temporarily stored in a dynamic random access memory (DRAM) 504. Algorithms needed for the operation of the DCP 507 are stored in an electrically erasable and programmable read-only memory (EEPROM) 505, but may alternatively be stored otherwise such as in an integral memory of the DCP 507. A memory card or other removably insertable storage media known in the art may be inserted into a memory card interface (MCI) 506.

The digital image signals from the DCP 507 are input into an LCD driving unit 514. In cooperation with the DCP 507, the driving unit 514 displays an image on the color LCD panel 35 relative to the digital image signals.

The digital image signals from the DCP 507 can also be transmitted as data (e.g., a JPEG data file) to an external device via, a USB connector 21a or a RS232C interface 508 and its connector 21b. Alternatively, the digital image signals from the DCP 507 can be transmitted as video signals via a video filter 509 and a video outputting unit 21c (e.g., an A/V or coaxial jack).

An audio processor 513 (e.g., an analog to digital converter) processes audio input signals received from a microphone MIC and sends the audio input signals to the DCP 507. Further, the audio processor 513 receives stored audio signals from a memory (e.g., DRAM 504, EEPROM 505, etc.) via the DCP 507 and outputs the audio signals to the speaker SP. As described hereafter in further detail, the camera 1 outputs an attention-grabbing sound via audio processor 513 and speaker SP.

The micro-controller 512 controls the operation of a flash controller 511 for operating the flash 12 according to a signal from the FS 19 or other photodetector (e.g., focus aiding means 18 shown in FIG. 1).

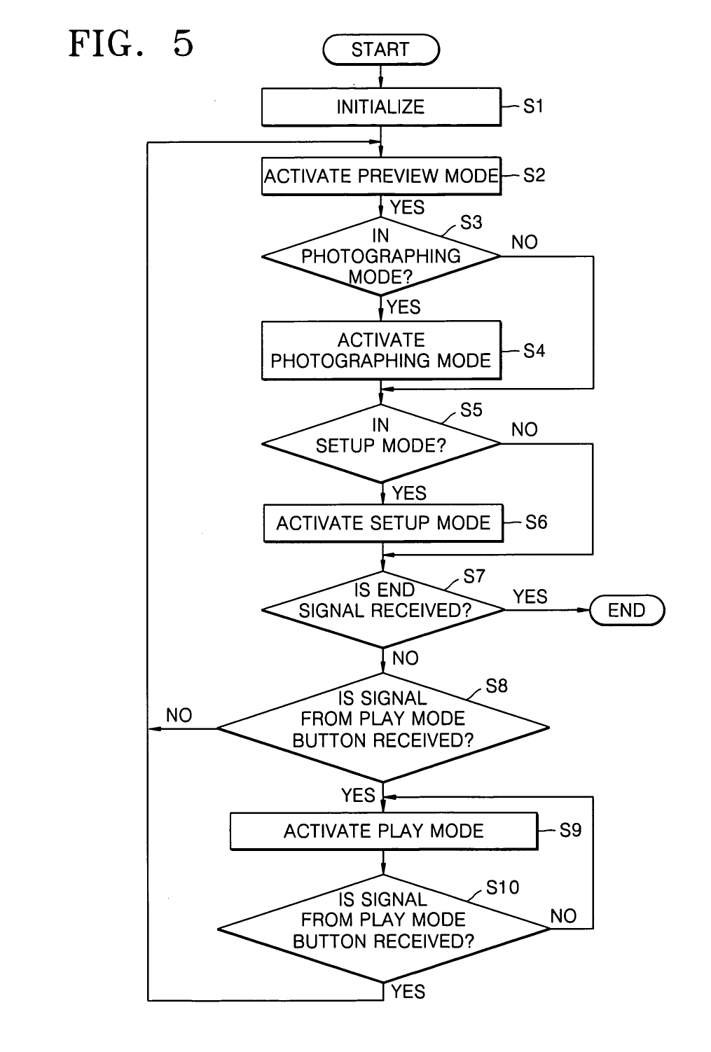

FIG. 5 is a flowchart illustrating a main algorithm of the DCP 507 illustrated in FIG. 3. The main algorithm of the DCP 507 will now be described with reference to FIGS. 1 through 5.

When power is supplied to the digital camera 1 the DCP 507 is initialized (Operation S1). If power is supplied to the digital camera 1 for the first time (e.g., an initial powering on of the camera 1 after purchase) and boots the digital camera 1, the processor subsystem, which comprises the DCP 507 in cooperation with the microcontroller 512, prompts the user via display panel 35 to select a language for displaying the text of menus, prompts, instructions, help and the like. The user selects a language via user input unit INP (e.g., function buttons 15) and the user input unit INP sends a selecting signal to DCP 507 relative to the user's selected on-screen display (OSD) language, which also corresponds to the selection of the language of an attention-grabbing sound output from the speaker SP during picture taking. The DCP 507 may be operative to display the text relative to various camera functions and settings in a plurality of languages, for example, 16 languages. Further, the selection signal of the OSD language may also simultaneously set an attention-grabbing sound in the same OSD language. Alternatively, the language for the attention-grabbing sound may be selected separately and independently of the OSD language.

The attention-grabbing sound is stored in advance when manufacturing the digital camera 1 so that the attention-grabbing sound has a clear sound quality. In some embodiments the attention-grabbing sound may be recorded by the user. The attention-grabbing sound may be a common expression in the selected language such as “smile” or “cheese” in English or “kimchi” in Korean that can grab the attention of one or more subjects. The attention-grabbing sound is a common expression in each of the 16 languages, and may be stored in the memory, for example, a flash memory (FM) 62. In an automatic audio output mode the attention-grabbing sound is automatically output when photographing. In a manual audio output mode the attention-grabbing sound is not output when photographing.

Also, in the initializing operation S1, a current time input signal is also input via the user input unit INP. When the current time input signal is input, the DCP 507 stores the input current time in the RTC 503. Thereafter, the RTC 503 may keep track of the time of day, day, date, year and the like for time-stamping of images and/or image data.

In addition, in the initializing operation S1, the DCP 507 outputs an initializing signal to each component of the digital camera 1 of FIG. 3 requiring initialization.

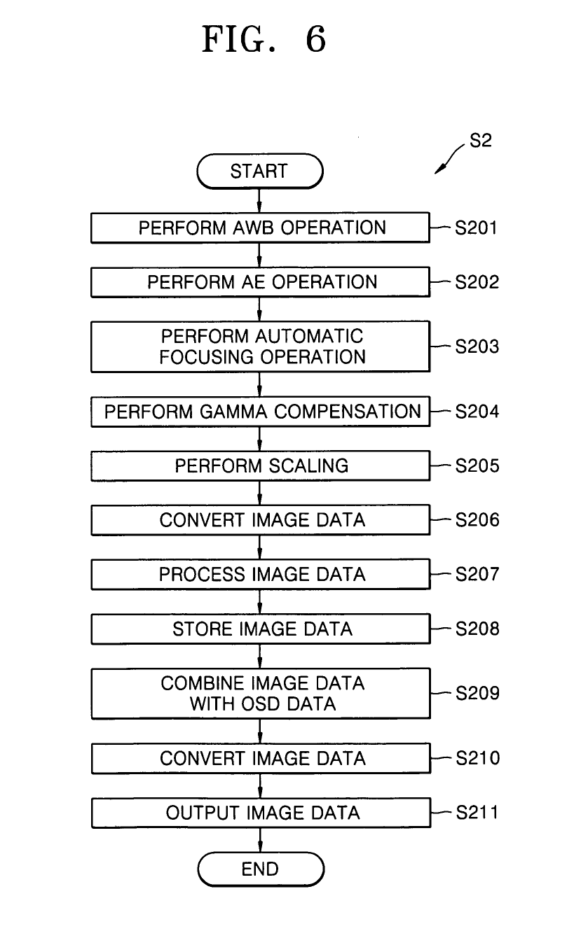

After the initializing operation S1, the DCP 507 activates a preview mode (Operation S2). In the preview mode an input image is displayed on the color LCD panel 35. Operations related to the preview mode will be described in more detail hereafter with reference to FIG. 6.

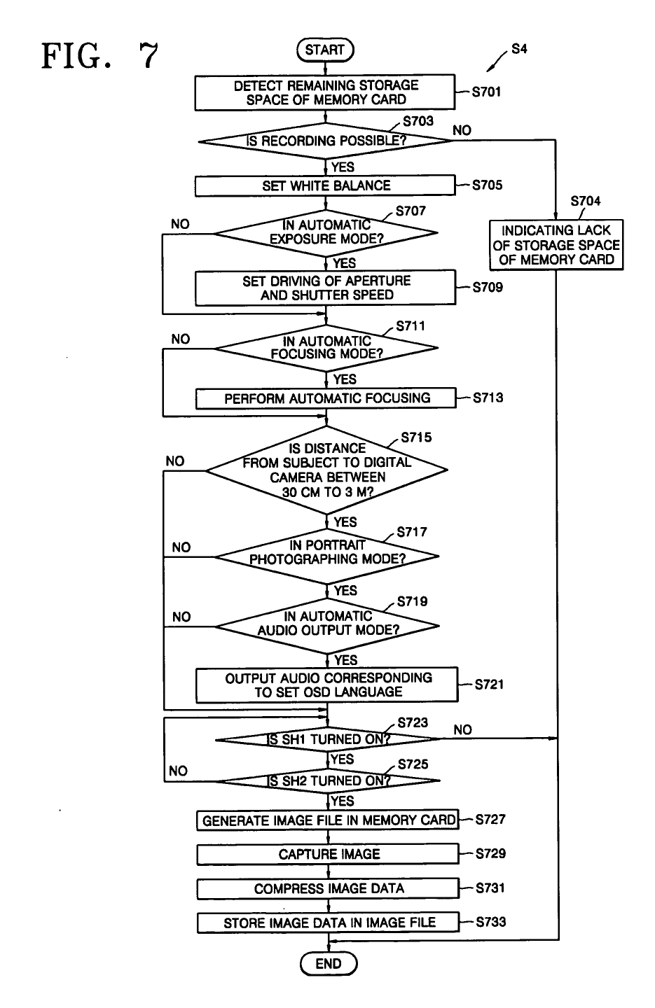

Next, when in the photographing mode in which the SH1 signal generated when the first step of the shutter release button 13 is pressed is turned “on” (Operation S3), the DCP 507 activates a photographing mode (Operation S4). An algorithm that outputs the attention-grabbing sound stored in the memory in advance before photographing according to the distance of a subject from the digital camera 1 will be described hereafter in further detail with reference to FIG. 7.

Then, if signals corresponding to a setup mode are among signals input from the user input unit INP (Operation S5), a setup mode is performed to set operating conditions according to the input signals (Operation S6).

There are various setups including “file name”, “auto power off”, “language”, and “time” settings. Signals of the setups are input via the menu/OK button 15-5 of the user input unit INP.

In relation to the “language” setup, if a selecting signal of one of the plurality of languages (e.g., 16 languages) that are set to be used in the OSD is input via the user input unit INP, the DCP 507 selects the corresponding language as the OSD language and simultaneously sets an attention-grabbing sound in the set OSD language. The attention-grabbing sound is a clear sound effect or vocalization that is stored in advance when the digital camera 1 is manufactured. As mentioned above, the attention-grabbing sound may be a common expression such as “smile”, “cheese”, or “kimchi”, and is stored in each of the 16 languages in the memory, for example, the FM 62.

Here, if a selecting signal regarding whether the attention-grabbing sound set in an automatic/manual mode is received by the microcontroller 512 and/or DCP 507 from the user input unit INP, the DCP 507 sets the audio output mode to the automatic/manual mode, respectively.

If an end signal is not generated, the DCP 507 continues to perform the following operations (Operation S7).

If a signal from the play mode button 30 in the user input unit INP is generated (Operation S8), a play mode is activated (Operation S9). In the play mode, operating conditions are set according to the signals input from the user input unit INP, and the playing operation is performed (e.g., displaying a recorded moving picture on the display 35). Next, if a signal from the play mode button 30 is again generated (Operation S10), the previous operations are repeated.

FIG. 6 is a flowchart illustrating an algorithm for performing the preview mode (Operation S2) shown in FIG. 5. The algorithm of operating the preview mode (Operation S2) shown in FIG. 5 will be described below in further detail with reference to FIGS. 1 through 3 and FIG. 6.

Referring now to FIG. 6, the DCP 507 performs an automatic white balance (AWB) operation and sets parameters related to the white balance (Operation S201).

When in an automatic exposure (AE) mode (Operation S202), the DCP 507 calculates an exposure level corresponding to the brightness of the image to be photographed, and sets a shutter speed by driving the aperture driving motor M_{A} according to the calculated exposure level (Operation S203).

Then, the DCP 507 performs gamma compensation on the input image data (Operation S204) and scales the gamma compensated input image data so that the image fits the display size (Operation S205).

Next, the DCP 507 converts the form of the scaled input image data from red-green-blue to brightness-chromaticity (Operation S206). The DCP 507 processes the input image data in relation to, for example, a resolution and a display location, and performs filtering (Operation S207).

Afterwards, the DCP 507 temporarily stores the input image data in the DRAM 504 (see FIG. 3) (Operation S208).

The DCP 507 combines the input image data temporarily stored in the DRAM 504 with OSD data (e.g., a date stamp) in Operation S209. Then, the DCP 507 converts the format of the combined image data from brightness-chromaticity to red-green-blue (Operation S210) and outputs the image data in the converted form to the LCD driving unit 514 (see FIG. 3) (Operation S211).

FIG. 7 is a flowchart illustrating an algorithm of the photographing mode (Operation S4) shown in FIG. 5. The algorithm of the photographing mode (Operation S4) shown in FIG. 5 will be described hereafter with reference to FIGS. 1 through 3 and FIG. 7. The algorithm starts when the SH1 signal, which is the signal generated when the shutter release button 13 is pressed to the first step, is “on”. At the instance when the SH1 signal is “on” the location of the zoom lens ZL (i.e., focal length of lens unit 20—FIG. 4) is already set.

First, the DCP 507 detects the remaining storage space of the memory card (Operation S701) and checks whether it is possible to store digital image signals (Operation S703). If there is not enough storage space the DCP 507 indicates lack of storage space in the memory card and then terminates the photographing mode (Operation S704). However, if there is enough storage space, the following operations are performed.

The DCP 507 sets white balance according to the currently set photographing conditions, and sets parameters related to the white balance (Operation S705).

Next, when in the AE mode (Operation S707), the DCP 507 calculates the exposure level corresponding to the brightness of the area to be photographed, drives the aperture driving motor M_{A} according to the calculated exposure level, and sets a shutter speed (Operation S709).

When in the automatic focusing mode (Operation S711), the DCP 507 performs automatic focusing and drives the focus lens FL (Operation S713). As the focus lens FL moves, locations of the focus lens FL at which high-frequency components of an image signal are highest, for example, the number of operating steps of the focus motor M_{F}, are set. A distance of the subject from the digital camera 1 can be calculated using experimental values regarding the relationship between the numbers of operating steps of the focus motor M_{F} and the distance of the subject from the digital camera 1.

After focusing the lens unit 20 and calculating the distance between the camera 1 and the subject, the DCP 507 determines whether the distance of the subject from the digital camera 1 is within a predetermined range, herein an exemplary range is illustrated and understood to be 0.3 m to 3 m (Operation 715). The predetermined range may, of course, be other known or desired ranges depending on the optics of the camera 1 among other design factors.

When the distance of the subject from the digital camera 1 is less than 0.3 m, photographing is performed in a macro mode, and when the distance is over 3 m, the DCP 507 recognizes that it is likely that a landscape is being photographed rather than a person. In the case when the distance is over 3 m, it is less likely that the attention-grabbing sound need be output. If the distance between the digital camera 1 and the subject is within the predetermined range, the next operation is performed.

The DCP 507 determines whether the photographing mode is a portrait photographing mode (Operation S717).

The portrait photographing mode can be set in the scene photographing mode via the user input unit INP. To output the attention-grabbing sound only when photographing people within the predetermined range, the DCP 507 determines whether the digital camera 1 is in the portrait photographing mode. If the digital camera 1 is in the portrait photographing mode, the next operation is performed.

The DCP 507 determines whether an audio output setting is set to the automatic audio output mode (Operation S719). More particularly, the DCP 507 determines whether the audio output setting of the attention-grabbing sound is set to the automatic audio output mode or the manual audio output mode in the initializing or the setup mode. If the audio output setting is set to the manual audio output mode, the DCP 507 does not satisfy the condition to output the attention-grabbing sound when photographing (i.e., the user has disabled the output of the attention-grabbing sound). However, if the audio output setting is set to the automatic audio output mode, the DCP 507 satisfies the condition to output the attention-grabbing sound, and the next operation is performed.

A vocalization in the set OSD language is output (Operation S721). The DCP 507 outputs the attention-grabbing sound stored in the FM 62 in one of the 16 languages set in the initializing operation S1 or the setup mode operation S5 via the speaker SP. The vocalization may be output after a predetermined amount of time, e.g., 1 or 2 seconds, after automatic focusing is performed. When the subject is detected to be located closer than 0.3 m or further than 3 m from the digital camera 1, the attention-grabbing sound is not output. Further, when the digital camera 1 is not in the portrait photographing mode or if the audio output setting is set to manual audio output mode, the set attention-grabbing sound is not output.

The DCP 507 performs the following operations if the SH1 signal from the shutter release button 13 is “on” (Operation S723).

First, the DCP 507 checks whether the SH2 signal is “on” (Operation S725). If the SH2 signal is not “on”, the user has not pressed the shutter release button to the second step and the DCP 507 repeats operations S723 and S725.

If the SH2 signal is “on”, the user has pressed the shutter release button to the second step and the DCP 507 generates an image file in the memory file, which is a recording medium (Operation S727). The DCP 507 continuously captures image data (Operation S729). That is, the DCP 507 receives image data from the CDS-ACD device 501. Then, the DCP 507 compresses the received image data (Operation S731), and stores the compressed image data in the image file (Operation S733).

The present invention also provides a digital camera adopting the method of controlling the digital camera 1 described with reference to FIGS. 5 through 7.

If a signal that selects one among the plurality of the OSD languages is input to the DCP 507 when the digital camera 1 is being booted for the first time in the initializing operation, or is in the setup mode in FIG. 7, the selected OSD language is set in the digital camera 1. At the same time, an attention-grabbing sound corresponding to the set OSD language is set. The attention-grabbing sound is one among the plurality of attention-grabbing sounds in different languages stored in advance when the digital camera 1 is manufactured. If a signal that sets audio output to automatic audio output is input to the DCP 507, the digital camera 1 is set to automatically output the attention-grabbing sound when photographing.

Next, when the SH1 signal, which is generated when the shutter release button 13 is pressed to the first step, is turned “on” and automatic focusing is performed, the digital camera 1 calculates the distance of a subject from the digital camera 1 according to the location of the focus lens FL, that is, the number of operation steps of the focus motor M_{F}. If the distance of the subject from the digital camera 1 is 0.3 m to 3 m, the photographing mode is set as the portrait photographing mode, and the preset attention-grabbing sound is output if the audio output is set as the automatic audio output mode. Also, the digital camera 1 may output the attention-grabbing sound 1 or 2 seconds after automatic focusing is performed. In a further embodiment, the camera 1 may control the volume of the attention-grabbing sound relative to the calculated distance of the subject from the digital camera 1. For example, if the subject is detected to be close (e.g., slightly greater than 0.3 m) to the camera 1, the volume of the sound may be set soft so as not to startle the subject. Conversely, if the subject is detected to be far (e.g., slightly less than 3 m) from the camera 1, the volume of the sound may be set loud to ensure that the distant subject hears the sound.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of photographing with a digital photographing apparatus including a two-step shutter release button, the method comprising:
focusing on a subject when a first-step signal of the shutter release button is turned “on”;
determining if the distance of the subject from the digital photographing apparatus is within a predetermined range; and
outputting an attention-grabbing sound corresponding to audio data stored in a memory.

2. The method of claim 1 further comprising the step of storing an image file of the subject in a recording medium when a second-step signal of the shutter release button is turned “on”.

3. The method of claim 1 further comprising the step of delaying the outputting step relative to a predetermined amount of time after the focusing step.

4. The method of claim 3 wherein the predetermined amount of time is within approximately 1-2 seconds.

5. The method of claim 1 wherein the predetermined range is between approximately 0.3 m and 3 m.

6. The method of claim 1 further comprising the step of determining if a portrait photographing mode is set.

7. The method of claim 1 further comprising the step of determining if an automatic audio output mode is set.

8. The method of claim 1 further comprising the steps of:
recording a first vocalization in a first language; and
storing the first vocalization to the memory for outputting as the attention-grabbing sound.

9. The method of claim 8 further comprising the steps of:
recording a second vocalization in a second language;
storing the second vocalization to the memory for outputting as the attention-grabbing sound; and
selecting at least one of the first and second vocalizations for outputting as the attention-grabbing sound.

10. The method of claim 1 further comprising the step of setting a volume for the attention-grabbing sound relative to the distance of the subject from the digital photographing apparatus.

11. A digital photographing apparatus comprising:
an optical system that automatically focuses on a subject;
a processor subsystem linked with the optical system for calculating a distance of the subject from the apparatus when the subject is focused, determining if the distance is within a predetermined range, and outputting an audio signal data when the distance is within the predetermined range; and
an audio processor linked with the processor subsystem and operative to receive the audio signal data and, responsive thereto, output an attention-grabbing audio signal.

12. The digital photographing apparatus of claim 11 wherein the processor subsystem comprises:
a micro-controller linked with a focus motor to focus on the subject; and
a digital camera processor in communication with the micro-controller for receiving a signal therefrom indicating that the distance is within the predetermined range, the digital camera processor being linked with a memory for retrieving the audio signal data from the memory and outputting the audio signal data to the audio processor.

13. The digital photographing apparatus of claim 12 wherein the focus motor further comprises a plurality of operating steps for moving a focus lens, wherein the micro-controller calculates the distance to the subject based on a number of steps required to focus on the subject.

14. The digital photographing apparatus of claim 11 wherein the predetermined range is from about 0.3 meters to about 3.0 meters.

15. The digital photographing apparatus of claim 12 wherein the optical system further comprises a photoelectric converter in optical communication with the focus lens for receiving a focused image of the subject, the photoelectric converter being linked with the digital camera processor via a combined correlation double sampler and analog to digital converter for sending an image signal.

16. A digital photographing apparatus that facilitates obtainment of a subject portrait by outputting an attention-grabbing sound in one of a plurality of languages, the apparatus comprising:
a language-setting means for selecting the language of the attention-grabbing sound from the plurality of languages, the language-setting means including an audio output means;
an imaging means for focusing on a subject and capturing a digital image thereof; and
a processing means in communication with the imaging means for determining a distance of the subject from the apparatus, the processing means linked with the audio output means for outputting the attention grabbing sound if the distance is within a predetermined range.

17. The digital photographing apparatus of claim 16 further comprising a display means for displaying the digital image and user-interactive menus, the language-setting means operative to set a text language of the menus.

18. The digital photographing apparatus of claim 16 wherein the processing means comprises at least one of a micro-controller and a digital camera processor.

19. The digital photographing apparatus of claim 16 wherein the imaging means comprises at least one of a photoelectric converter of a charge coupled device and a complementary metal oxide semiconductor.

20. The digital photographing apparatus of claim 16 wherein the predetermined range is from approximately 0.3 to 3.0 meters.
